(19) United States
(12) Patent Application Publication
(10) Pub. No.: US 2005/0102275 A1
(43) Pub. Date: May 12, 2005

(54) Method and system for intelligent searching of crude oil properties and knowledge

(76) Inventors: Michael Adam Kinstrey, Ballston Spa, NY (US); Mark Dausch, Castleton, NY (US)

Correspondence Address: Patrick Patnode, Esq.;General Electric Compamy, 1 River Road, Schenectady, NY, 12345, US

(21) Appl. No.: 10/703,218

(22) Filed: Nov. 6, 2003

(51) Int. Cl. G06F 11/30

(52) U.S. Cl. 707/3

(57) ABSTRACT

A method and system for accessing crude refinement related information stored in a database for assessing and optimizing crude refinement are provided. A fuzzy search engine searches a database storing records of crude refinement related data, each record having at least one field. The fuzzy search engine receives at least one search request, respective search requests including search criteria including at least one search parameter specifying a field of the at least one field and a search criteria type corresponding to each search parameter specifying a target value and a relationship to the target value. The fuzzy search engine further includes an algorithm for computing for each respective search parameter a degree of membership value for individual records in accordance with at least one continuous varying function describing a degree of meeting the search criteria type corresponding to the respective search parameter by data stored in the field specified by the respective search parameter. The fuzzy search engine further includes an algorithm for computing a closeness value for each individual record in accordance with a function combining the degree of membership value for each respective search parameter.

### FIELD OF THE INVENTION

The present disclosure relates to the refining of crude oil, and particularly to a method and system for assessing and optimizing crude selection and operating conditions of refineries. Specifically, the present disclosure relates to a method and system to broadly search stored information to assist oil refineries in assessing and selecting crudes and crude blends that are not of optimum quality, as well as selecting appropriate chemical treatments and conditions to minimize operating problems with processing such crudes.

### BACKGROUND OF THE INVENTION

Oil refineries are under intense pressure to process lower quality crudes for reasons of price or availability. However, in many cases, oil refiners do not possess enough information and knowledge about certain crudes and how they behave in an operating environment to make processing these crudes feasible and optimal. Individual refiners only have access to operational information and experiential knowledge about crudes they have actually used or tested.

In an effort to address the problem of not possessing enough information about certain crudes and how they behave in an operating environment, some refiners have used laboratory simulations to develop predictive models of certain performances. These models, however, are limited and do not address specific, often complex problems that may arise during processing of these crudes and how these problems can be alleviated by using appropriate chemical treatment solutions.

Linear programming systems have also been implemented which focus on defining crude cut and the corresponding cut yield, but these systems do not address the use of treatment chemicals in the crude selection mode. These methods cannot tell refiners how the crude blends will affect operations and equipment. Therefore, refiners lack important information necessary to access the economic viability of using these crudes.

Furthermore, searching capabilities for finding information are usually capable of searching for an exact match for a value or for a range, where the ability to find information is limited unless the user knows exactly what to search for.

Accordingly, there is a need for a method and system for intelligently broadly searching through crude and refinery related information for locating information similar to what is being searched for which overcomes drawbacks in prior art methodologies and systems.

### BRIEF DESCRIPTION OF THE INVENTION

The present invention provides a method and system for accessing crude refinement related information similar to at least one target value for assessing and optimizing crude refinement. The system includes a database and a fuzzy search engine having programmable instructions configured for execution by at least one processor receiving and processing at least one search request. The database includes a plurality of records collectively storing data related to at least one of a plurality of crudes, crude slates and refinery operating conditions, each record having at least one field storing data. The respective search requests include search criteria including at least one search parameter specifying a field and a search criteria type corresponding to each search parameter specifying a target value and a relationship to the target value.

The fuzzy search engine includes an algorithm for computing for each respective search parameter a degree of membership value for individual records in accordance with at least one continuous varying function describing a degree of meeting the search criteria type corresponding to the respective search parameter by data stored in the field specified by the respective search parameter. The fuzzy search engine further includes an algorithm for computing a closeness value for each individual record in accordance with a function combining the degree of membership value for each respective search parameter.

The method includes the steps of accessing a database and executing at least one fuzzy search. The database stores data in a plurality of records related to at least one of a plurality of crudes, crude slates and refinery operating conditions. Each record has at least one field storing data. The fuzzy search includes the step of receiving at least one search request, where respective search requests include search criteria. The search criteria includes at least one search parameter specifying a field and a search criteria type corresponding to each search parameter which specifies a target value and a relationship to the target value.

The fuzzy search further includes the step of computing for each respective search parameter a degree of membership value for individual records in accordance with at least one continuous varying function describing a degree of meeting the search criteria type corresponding to the respective search parameter by data stored in the field specified by the respective search parameter. The fuzzy search further includes the step of computing a closeness value for each individual record in accordance with a function combining the degree of membership value for each respective search parameter.

Steps of the methods of the invention may be implemented by executing programmable instructions by a processor, where the programmable instructions or a portion thereof are stored on a computer readable medium or included in a computer data signal embodied in a transmission medium.

### BRIEF DESCRIPTION OF THE DRAWINGS

FIG. 1 is a block diagram of an illustrative embodiment of a system for accessing and optimizing crude refinement processes in accordance with the present invention;

FIG. 2 is a block diagram of a fuzzy search engine in accordance with the present invention;

FIG. 3 is a flowchart of the steps performed by the fuzzy search engine shown in FIG. 2; and

FIG. 4-11 are exemplary distributive functions for determining a degree of membership, in accordance with the present invention.

### DESCRIPTION OF THE PREFERRED EMBODIMENT

The invention provides a method and system for intelligently and broadly searching through crude and refinery related information for locating information similar to what is being searched for. In one aspect, the invention makes use of a database storing a massive amount of data, including experiential data related to different types of crudes, their test characterizations, operating conditions under which the crudes have been processed along with any associated processing difficulties and/or performance or risk parameters, and laboratory simulation data.

The invention provides a fuzzy search engine which accesses and uses the data stored in the database. The fuzzy search engine takes as input user search selections including at least one search parameter relating to crude refinery elements, such as crudes, crude slates, historically reported or potential problems relating to refining of crudes, chemicals to use during the refining process and refinery conditions; and search criteria, a fuzzy parameter, and a weight value associated with individual search parameters. The fuzzy search engine searches the database and retrieves a list of qualifying records that meet the entered search criteria. The fuzzy search engine computes a degree of membership value in accordance with a continuous varying function for each of the field values comprising one qualifying record, and further computes a closeness value using the degree of membership values. The qualifying records and their corresponding degree of membership and closeness values are output and ranked in order based on the computed closeness values.

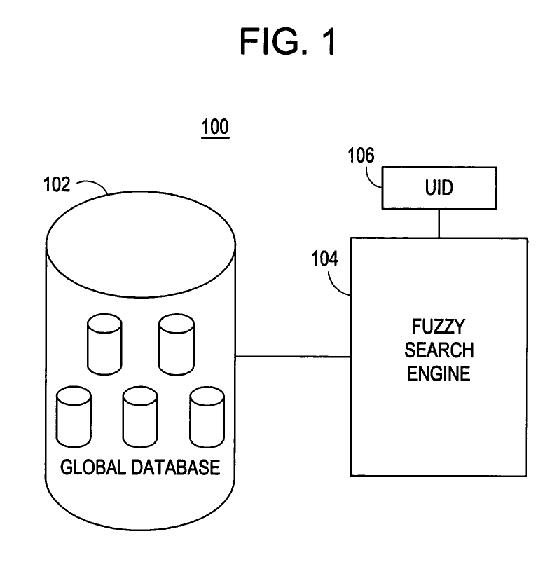

With reference to FIG. 1, there is shown a block diagram of a system for assessing and optimizing crude selection and operating conditions of refineries designated generally by reference numeral 100. The system 100 includes a database 102 storing a massive amount of crude data, including sub-databases, such as crudes, crude slates, operating conditions in crude refineries, problem report contents for problems encountered (actually or theoretically) during refining processes, and chemicals used during the refining process for countering potential or actual problems. The sub-databases collectively hold experiential data, related to different types of crudes, their test characterizations, refineries and their operating conditions under which the crudes were processed along with any associated processing difficulties and/or performance or risk parameters, and laboratory simulation data. The method and system allow a user to broadly search for crude data based on user entered search criteria including at least one search parameter, and a search criteria type and/or a fuzzy parameter for each search parameter.

The system 100 includes a database 102 that can be remotely located from the fuzzy search engine 104 and connected to the fuzzy search engine 104 via conventional networking systems, such as a LAN, WAN, the Internet, etc. Preferably, the database 102 includes sub-databases, including a crude sub-database 121, a crude slate sub-database 122, an operating condition sub-database 123, a chemical sub-database 124 and a problems related to refining sub-database 125. The sub-databases may be separate databases, linked databases or included in one database where the sub-database indication is provided within a field, or the equivalent, as known in the art.

The fuzzy search engine 104 further receives at least one search request including user entered information, which may be user entered via a user interface device (UID) 106. The UID 106 may include means for providing information to the user, such as a display device for displaying a graphical user interface (GUI), and/or at least one input device for enabling a user to provide information to the fuzzy search engine 104, such as a mouse, keyboard and/or touchpad, etc. The user entered information includes information needed for searching the database 102, and may include information needed for broadly searching the database 102 when a broad search is requested. The fuzzy search engine 104 accesses the database 102 in accordance with the search request, and intelligently searches for the data requested.

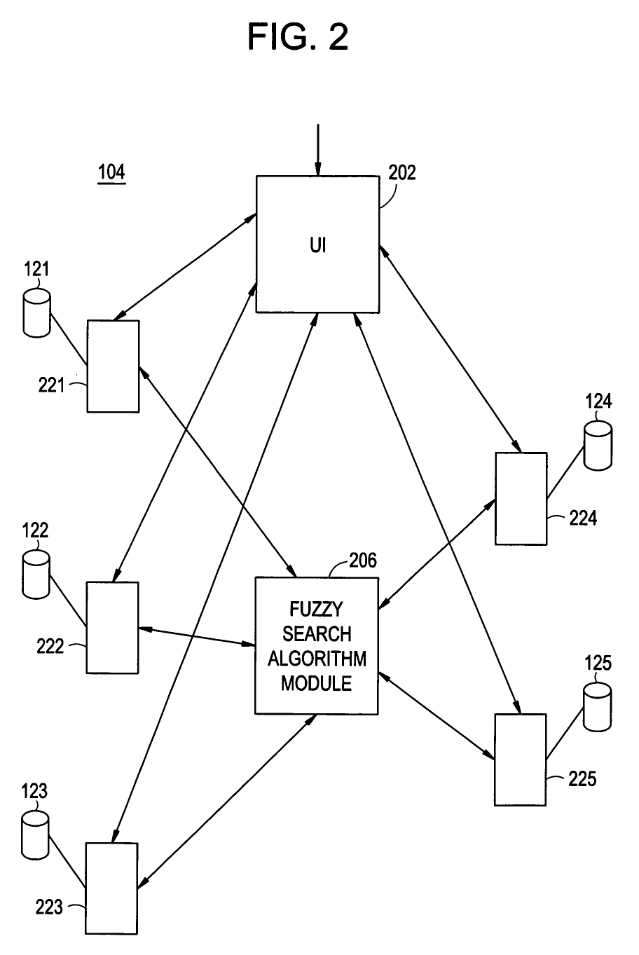

FIG. 2 is an exemplary block diagram of the fuzzy search engine 104. The fuzzy search engine 104 includes a user interface (UI) module 202 for receiving entered data and interfacing with UID 106, and at least one sub-search module, including crude sub-search module 221, crude slate sub-search module 222, operating condition sub-search module 223, chemical sub-search module 224, and problems related to refining sub-search module 225. The fuzzy search engine 104 further includes a fuzzy search algorithm module 206. It is contemplated that the functions of the various modules and fuzzy search engine 104 may be distributed among the models and engine in accordance with design choice. At least a portion of the various functions or methods of the fuzzy search engine 104 are performed by these modules, as further described below, by utilizing information stored in the database 102 and by having at least one processor execute a set of programmable instructions corresponding to each of the modules.

Hence, the fuzzy search engine 104 is a programmable engine which includes all of the sets of programmable instructions corresponding to each of the modules. The programmable instructions or a portion thereof can be stored on the at least one processor. The programmable instructions or a portion thereof can also be stored on a computer readable medium or included in a computer data signal embodied in a transmission medium.

Upon executing the programmable instructions, the system 100 of the invention provides a technical effect. The technical effect is to output results of fuzzy searches indicating stored experiential crude information having similar parameters to user entered parameters including an indication of the degree of similarity (membership) of the results relative to the user entered parameters, and further indicating the desirability of suggested refinement process using experiential crude and refinery operating condition information, chemical treatments and predicted performance or risk information, as well as any other relevant information.

With continued reference to FIG. 2, the UI module 202 receives the user entered information. Alternatively, information provided to the UI module 202 may be provided by other means, such as a processor which may be included in or separate from the fuzzy search engine 104. The UI module 202 provides received information to the appropriate sub-module 221-225. Each of the sub-modules 221-225 is provided with access to a respective sub-database 121-125 for searching the sub-database and retrieving information therefrom.

Furthermore, each of the sub-modules 221-225 is in communication with fuzzy search algorithm module 206 for requesting a fuzzy search, including providing fuzzy search information to the fuzzy search algorithm module 206, and receiving fuzzy search results from the fuzzy search algorithm module 206, as described in further detail below. The sub-modules 221-225 process the received fuzzy search results and provide selected information from the received fuzzy search results and/or information accessed from the respective sub-database 121-125 as output, such as output to the user via the user interface module 202, or as output to another module, such as a module that performs analysis on the search results.

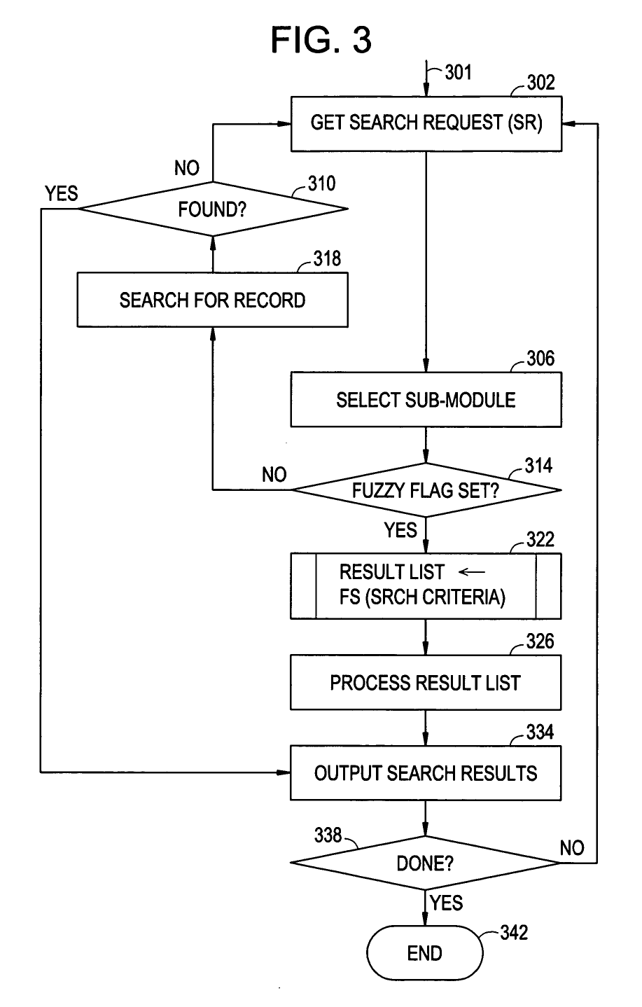

With respect to FIG. 3, a flowchart showing steps for processing of a search request 301 is provided. The flowchart is exemplary and is not limited to the steps shown. The method of the invention can be implemented using other steps or orders of steps. At step 302, the user (or other entity) is prompted to enter at least one search request 301 via the UI module 202, or if a queue of already entered search requests 301 exists, the next search request 301 is retrieved from the queue for processing. If more than one search request 301 was entered, one search request 301 is retrieved for processing and the remaining search requests 301 are stored on the queue. Each search request 301 includes search criteria, where the search criteria provides information for searching a specific sub-database for one or more records that store data as specified by the search criteria.

The search criteria includes a sub-database indication indicating the sub-database 121-125 to be searched, where the sub-database indication may be a separate piece of information included in the user request, either initially or in response to a prompt from the UI module 202, or may be included in the search criteria.

The search criteria includes at least one search parameter, a search criteria type, corresponding to each respective search parameter, a fuzzy search request flag and optionally a fuzzy parameter and/or a weight value corresponding to each respective search parameter. Each search parameter specifies a field holding data values to be searched in the database 102. For example, when the crude sub-database 121 is being searched, the parameter typically relates to chemical and/or physical characteristics of a crude, e.g., pH, pour point, sulfur content, viscosity, etc. When the crude slate sub-database 122 is being searched, the parameter typically relates to composition qualities of the crude slate, e.g., percent of a particular crude in the slate. When the operation conditions sub-database 123 is being searched, the parameter typically relates to conditions existing within a refinery, e.g., tower top temperature, wash water flow rate, raw percentage Basic Sediment and Water (BSW), raw crude salt content, overhead pressure, overhead pH, etc. When the chemicals database is being searched, the parameters typically include chemical properties, such as rate, dosage, injection location, frequency (continuous or intermittent), etc. When the problems related to refining process sub-database 125 is being searched, the parameters typically include problem values, such as corrosion rates, sensor location coordinates, fouling, emulsion, etc.

The search criteria type specifies a target value and a relationship to the target value, such as a range relative to the target value for defining a range of values being searched for. For example, the search criteria type may be an exact match (i.e., equality (=)), or a range-match (i.e., bounded conditions having at least one of a lower and upper boundary, such as <, >=, between, etc.).

The fuzzy search flag indicates when a broad search is requested for the corresponding parameter, i.e., that the fuzzy search algorithm module 206 will be used for processing the search for the corresponding parameter.

The fuzzy parameter specifies a plus-or-minus (+/−) parameter z, or a (+) parameter z1 and a (−) parameter z2 used in conjunction with the search criteria type for defining a degree of membership function, as described further below. The fuzzy parameter specifies at least one of a first range of values extending above the target value and a second range of values extending below the target value for defining the relationship to the target value, and wherein the search criteria are met for values within the first and second ranges, and the degree increases for values closer to the target value.

The weight value indicates the importance of the corresponding parameter being searched. In the example provided a weight value is selected from High=5, Medium=3, and Low=1, where the default is one, i.e., unweighted. It is contemplated that the weight value may be a variable selected from a set of possible values, where a function is computed using the variable.

At step 306, the appropriate sub-module 221-225 corresponding to the sub-database 121-125 specified in the search request is selected. At step 314, the selected sub-module determines if the fuzzy search flag is set, indicating that a broad search is requested. If the determination is “NO”, then control passes to step 318. At step 318, the selected sub-module 221-225 searches for each record in the corresponding sub-database 121-125 which has values in fields corresponding to the at least one search parameter that meet the corresponding search criteria type. At step 310, a determination is made if the information requested was properly found. If “YES”, control passes to step 334. If at step 310 the determination is “NO”, a “search unsuccessful” message is generated for display to the user and control passes to step 302 for receiving an updated or corrected search request.

If the determination at step 314 was “YES”, then at step 322 the selected sub-module 221-225 passes the search criteria and the sub-database being accessed to the fuzzy search algorithm module 206. The fuzzy search algorithm module 206 executes a fuzzy search algorithm (FS(search criteria)) using four functions including a transformation/normalization function, a degree of membership function, a rule applicability function, and a defuzzification function.

The transformation/normalization function, which is used optionally, normalizes individual search parameters by determining for a field corresponding to an individual search the field's expected data range, converting the range to [0,1] and mapping proportionately each search parameter value or field value to a value between 0 and 1. For example, the pH field for a crude record has a range of 0 to 14, so the transformation function would convert specific pH search parameter value of 7 to be 0.5. Transforming a data range is an optional step, since most distribution functions can be applied to the original data range, as shown in the example that follows.

The degree of membership function is a distribution function that determines how well an accessed field value meets the search criteria type. Different distribution functions can be used to represent the desired degree of membership function, depending on the selected search criteria type and fuzzy parameter. For example, the user may choose for one search parameter to have a distribution function which determines field values that are as close to a selected value as possible, while for another search parameter a distribution function is used that determines minimum field values. The distribution function includes at least one continuous function that is varying.

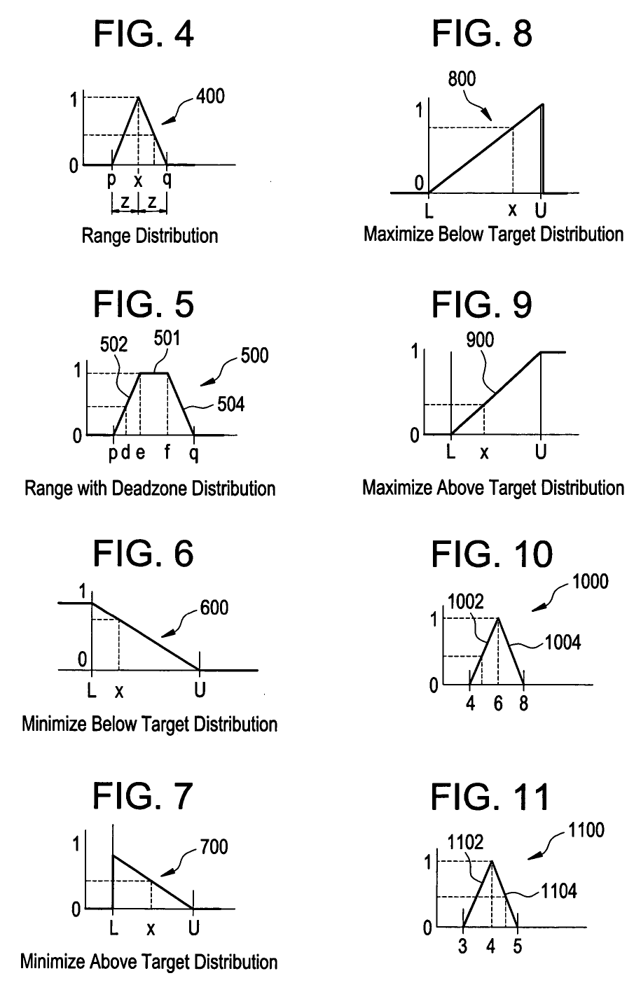

An explanation of several examples of distribution functions follows, with respect to FIGS. 4-11. Distribution functions are not limited to the functions shown, and other functions may be used. For each distribution function, as the value for y is proportional with the degree of membership, and y ranges between [0,1], the closer y is to 1 the higher the degree of membership. FIG. 4 shows a plot 400 for an exemplary Range Distribution function, which represents a degree of membership value for a search criteria type [field value=x], and the fuzzy parameter=[+/−z], where a determination is made for field values to determine if they are between the range of p and q, inclusive, and where the degree of membership increases as the value approaches the center of the range, and decreases as the value moves away from the center. For a field value of x which is exactly between p and q, the degree of membership along the Y axis is 1. Similarly, if the field value of x is between x and q, the degree of membership would be less (e.g. 0.4). It follows that p=x−z and q=x+z. Using two known points and the function y=mx+b, we can compute a y value along the lines to either side of x for determining degree of membership. It is further contemplated that the fuzzy parameter may not be symmetric, such as [+z1, −z2], where z1 is not equal to z2.

This distribution function may also be used for a search in which the search criteria type includes a specified lower or upper bound, such as [field value<=target], and fuzzy parameter [−z]. Since all values will be less than the target value, the right half of the distribution function is not used. Likewise for a search using search criteria type [field value>=target] and fuzzy parameter [+z], the left half of the distribution is unused.

An exemplary Range with Deadzone Distribution function is shown by curve 500 in FIG. 5, which behaves similarly to the distribution function shown in FIG. 4, but includes a “dead zone” 501 where any value within a specified range has the same degree of membership. All field values that are between e and f have a degree of membership of 1. Field values that are between p and e (e.g., d), or between f and q have a lower degree of membership, in accordance with the slope of the lines 502, 504, respectively. This function is used for search criteria type [e<=field value<=f], and fuzzy parameter [+/−z], where p=e−z, q=f+z. The degree of membership is determined by first checking to see if the field value is between e and f., and if not applying the function y=mx+b.

An exemplary Minimize Below Target Distribution function is shown by curve 600 in FIG. 6, which is used when a search parameter is minimized below a given upper bound U, and above a lower bound L. The lower the value for “x”, the higher the degree of membership. The function y=(U−x)/(U−L) can be used to determine the degree of membership when L<=x<=U. If the value “x”<=L, the degree of membership is always one (1). If the value “x”>=U, the degree of membership is always zero (0).

An exemplary Minimize Above Target Distribution function is shown by curve 700 in FIG. 7, which is used when minimizing a search parameter above a lower bound L. If value “x”<L, the degree of membership is always zero (0). Upper bound U is a value above which the degree of membership is always zero (0). The function y=(U−x)/(U−L) can be used to determine the degree of membership when L <=x<=U.

An exemplary Maximize Below Target Distribution function is shown by curve 800 in FIG. 8, which is used when a search parameter is maximized up to an upper bound U. The function y=(x−L)/(U−L) can be used to determine the degree of membership. All values of “x”>U always yield a degree of membership of zero (0). All values of “x”<=L always yield a degree of membership of zero (0).

An exemplary Maximize Above Target Distribution function is shown by curve 900 in FIG. 9, which is used for maximizing a search parameter above a lower bound L and below an upper bound U. Any value of “x”<=L always has a degree of membership of zero (0). Any value of “x”>=U always has a degree of membership of one (1). The function y=(x−L)/(U−L) can be used to determine the degree of membership where L<=x<=U.

Although fuzzy parameters are not specified for the functions describing the curves shown in FIGS. 6-9, the search is broad (fuzzy) as the degree of membership varies in accordance with the appropriate function.

The third function of the fuzzy search algorithm is the rule applicability function, which determines the degree to which a rule (or distribution function) fires for a specific search parameter. In general, a search parameter may have several distribution functions that may be applied to varying degrees, each with a different applicability score. In the present example, only one distribution function is provided per parameter, so the rule applicability function is not needed. However, it is contemplated that more than one distribution function may be provided for a search parameter, and weight values may be provided for corresponding to the respective distribution functions for use when determining a degree of membership.

The fourth function of the fuzzy search algorithm is the defuzzification function, which calculates a closeness value for each record based on the summation of degree of membership values for each field value that corresponds to a search parameter, the respective weight values for each search parameter, and how many search parameters and/or weight values or totals thereof were involved in the scoring. For example, a High weight value increases the importance of the corresponding degree of membership value when calculating the final closeness value. The following exemplary function can be used for determining the closeness value for each record R having a degree of membership value αᵢ for each field corresponding to a search parameter spᵢ, for a weight value Wᵢ applied to each respective search parameter spᵢ

$$Equation ( 1 ) \text{:} \\ \text{Closeness Value} ( CV ) = \frac{{\sum }_{i = 1}^{a} {α}_{i} {W}_{i} }{{\sum }_{i = 1}^{n} {W}_{i}}$$

In the following example use of the fuzzy search algorithm is demonstrated. A user wants to find all crude oils where the pH=6, +/−2, and the Total Acid Number (TAN)=4+/−1. The user further assigns a weight value of High to the pH search parameter, and a Medium weight value to the TAN search parameter.

The search parameters are pH and TAN. The search criteria for pH is [field value=6], the fuzzy search flag is set, the fuzzy parameter is [+/−2], the weight value is W=5. The search criteria for TAN is [field value=4], the fuzzy search flag is set; the fuzzy parameter is [+−1], the weight value is W=3.

The fuzzy search considers the following three database records:
Crude A: pH=5.0, TAN=4.5
Crude B: pH=5.5, TAN=5.0
Crude C: pH=6.0, TAN=5.0

To determine the degree of membership value for the pH values, the distribution function shown by curve 1000 in FIG. 10 is used. To determine the degree of membership value along the Y axis, a determination is made as to whether the pH values for each crude record lie on line 1002 or on line 1004. The pH values for Crudes A, B and C (5.0, 5.5, 6.0, respectively) lie on line 1002. Line 1002 is described by the general function for the line 1002 extending between coordinates (4,0) and (6,1), i.e., y=mx+b, where y is the degree of membership value, m is the slope of the line, and b is the y intercept of the line. In order to calculate the y value, m and b must first be determined.

The slope of a line is defined as m=(y2−y1)/(x2−x1). Plugging in the line end points, m=(1−0)/(6−4) or m=1/2. Plugging in point (4,0), 0=(1/2)4+b, which reduces to b=−2.

The degree of membership value (y) is calculated for each of the pH values for crudes A, B, and C as follows:
For crude A, y=(1/2)5.0+(−2), or y=0.50.
For crude B, y=(1/2)5.5+(−2), or y=0.75.
For crude C, y=(1/2)6.0+(−2), or y=1.00.

If a pH value greater than 6 was considered, the formula for line 2004 would be calculated by determining the slope and y-intercept of the line extending between coordinates (6,1) and (8,0), which would be used to determine the degree of membership value.

To determine the degree of membership value for the TAN values, the distribution function shown by curve 1100 in FIG. 11 is used.

To determine the degree of membership value along the Y axis, a determination is made as to whether the TAN values for each crude record lie on line 1102 or on line 1104. The TAN values for Crudes A, B and C (4.5, 5.0, 5.0, respectively) lie on line 1104. Line 1104 is described by the general function for the line 1102 extending between coordinates (4,1) and (5,0). The slope m=(0−1)/(5−4)=−1. The y intercept is calculated using point (5,0), which give 0=(−1)(5)+b, which reduces to b=5.

The degree of membership value (y) is calculated for each of the TAN values for crudes A, B, and C as follows:

The degree of membership value (y) is calculated for each of the TAN values for crudes A, B, and C as follows:
For crude A, y=(−1)4.5+(5), or y=0.50.
For crude B, y=(−1)5.0+(5), or y=0.00.
For crude C, y=(−1)5.0+(5), or y=0.00.

The rule of applicability function is not applied at this stage as one distribution function is used per parameter.

The defuzzification function is executed for computing the overall closeness value for each of crudes A, B, and C. Using equation (1):
For Crude A: CV=((0.50)(5)+(0.50)(3))/(5+3)=0.50
For Crude B: CV=((0.75)(5)+(0)(3))/(5+3)=0.468
For Crude C: CV=((1.00)(5)+(0)(3))/(5+3)=0.625

Due to the High weighting of pH in accordance with the user's weight value assignments, crude C has a higher Closeness Value than crude A, even though crude C's TAN value had a much lower degree of membership.

The fuzzy search algorithm module 206 outputs a result list including a list of closeness values and corresponding record information for records having values in fields corresponding to the search parameter that met the broad search criteria. The output record information is ranked in accordance with the closeness values. The record information may include only identifiers for each record, or additional information, such as field values.

At step 326, the result list is processed. If the result list is empty a message is displayed to the user indicating that no records were found that met the search criteria, and the user is given the option to modify the search criteria and perform the search again, or to exit the program. For a result list having one or more record entries, the information in the result list is displayed to the user. Additional information may be displayed to the user, such as additional field information for each record included in the results list. The user is given the opportunity to select records from the result list. The ranking of the result list may assist the user in making selections. Alternatively, the result list may be analyzed by executing an algorithm for selecting records from the result list, where selection is based on the computed closeness value.

At step 334, the selected records are output as search results, such as by outputting the search results to a GUI generated by the UI 202, to another processing module, e.g., a module, such as a module that performs analysis upon the search results and/or uses the search results for generating other results, and/or to a buffer for storing the search results. The search results may include all or some of the information stored in fields corresponding to the selected records, or only an identifier for the selected records.

At step 338, a determination is made if the processing of the search request(s) is done. If “NO”, control passes to step 302, and if “YES”, then an end step is processed at step 342. It is envisioned that multiple requests may be processed at one time by using parallel processing methods.

The search results output by the fuzzy search engine 104 may be analyzed for determining desirability of at least one combination of the selected records for at least one search request, including at least one of accessing treatment options stored within the database suitable for optimizing performance of the refining process; performance analysis including predicting performance and determining the probability and distribution of problems during the refining process; and treatment analysis. U.S. patent application Ser. No. 10/643,191 describes a system and method providing a predictive engine for predicting performance, performing performance analysis and suggesting and analyzing treatments, the contents of which are incorporated herein by reference in their entirety. Search results from the fuzzy search engine 104 could be provided to the predictive engine, and furthermore, it is envisioned that the predictive engine enter search requests to the fuzzy search engine 104 for analysis thereof.

The described embodiments of the present disclosure are intended to be illustrative rather than restrictive, and are not intended to represent every embodiment of the present disclosure. Various modifications and variations can be made without departing from the spirit or scope of the present disclosure as set forth in the following claims both literally and in equivalents recognized in law.

1. A system for accessing crude refinement related information similar to at least one target value for assessing and optimizing crude refinement comprising:
a database including a plurality of records collectively storing data related to at least one of a plurality of crudes, crude slates and refinery operating conditions, each record having at least one field storing data; and
a fuzzy search engine having programmable instructions configured for execution by at least one processor for receiving and processing at least one search request, respective search requests including search criteria including at least one search parameter specifying a field of the at least one field and a search criteria type corresponding to each search parameter specifying a target value and a relationship to the target value; wherein the fuzzy search engine comprises:
an algorithm for computing for each respective search parameter of the at least one search parameter a degree of membership value for individual records of the plurality of records in accordance with at least one continuous varying function describing a degree of meeting the search criteria type corresponding to the respective search parameter by data stored in the field specified by the respective search parameter; and
an algorithm for computing a closeness value for each individual record in accordance with a function combining the degree of membership value for each respective search parameter.

2. The system in accordance with claim 1, wherein the database further includes a plurality of records collectively storing data related to at least one of a plurality of chemicals for use during refining of crudes and a plurality of problems related to refining of crudes.

3. The system in accordance with claim 1, wherein the algorithm for computing a closeness value outputs a list of records of the individual records ranked in order in accordance with the closeness value corresponding to each of the listed records.

4. The system in accordance with claim 1, wherein the search criteria further includes a weight value corresponding to respective search parameters of the at least one search parameter, and wherein the closeness value for each individual record is computed by weighting each degree of membership value for each respective search parameter in accordance with the corresponding weight value.

5. The system in accordance with claim 1, wherein the programmable instructions or a portion thereof are stored on a computer readable medium or included in a computer data signal embodied in a transmission medium.

6. The system in accordance with claim 1, wherein the relationship to a target value x specified by the search criteria type includes x bounded by at least one of an upper and a lower bound.

7. The system in accordance with claim 1, wherein the system further comprises at least one user input device for receiving the at least one search request.

8. The system in accordance with claim 7, wherein the algorithm for computing a closeness value outputs a list of records of the individual records and the respective corresponding computed closeness value, and wherein the at least one user input device further receives user input for selecting records from the list of records.

9. The system in accordance with claim 1, wherein the search criteria for a search request includes a unique fuzzy parameter corresponding to respective search parameters of the at least one search parameter for specifying at least one of a first range of values extending above the target value and a second range of values extending below the target value, wherein the first and second ranges define the relationship to the target value, and wherein the search criteria are met for values within the first and second ranges, and the degree of membership varies with respect to a difference between a value within the range and the target value.

10. A method for assessing and optimizing crude selection comprising the steps of:
accessing a database for obtaining data related to at least one of a plurality of crudes, crude slates and refinery operating conditions, stored in a plurality of records, each record having at least one field storing data; and
executing at least one fuzzy search comprising the steps of:
receiving at least one search request, respective search requests including search criteria including at least one search parameter specifying a field of the at least one field and a search criteria type corresponding to each search parameter specifying a target value and a relationship to the target value;
computing for each respective search parameter of the at least one search parameter a degree of membership value for individual records of the plurality of records in accordance with at least one continuous varying function describing a degree of meeting the search criteria type corresponding to the respective search parameter by data stored in the field specified by the respective search parameter; and
computing a closeness value for each individual record in accordance with a function combining the degree of membership value for each respective search parameter.

11. The method in accordance with claim 10, further comprising the step of outputting a list of records of the individual records ranked in order in accordance with the closeness value corresponding to each of the listed records.

12. The method in accordance with claim 10, wherein the search criteria further includes a weight value corresponding to respective search parameters of the at least one search parameter, and wherein the computing a closeness value step includes the step of weighting each degree of membership value for each respective search parameter in accordance with the corresponding weight value.

13. The method in accordance with claim 10, wherein the relationship to a target value x specified by the search criteria type includes x bounded by at least one of an upper and a lower bound.

14. The method in accordance with claim 10, further comprising the steps of:
outputting a list of records of the individual records and the respective corresponding computed closeness value; and
receiving input for selecting records from the list of records.

15. The method in accordance with claim 14, further comprising the step of processing data included in the selected records for determining desirability of at least one combination of the selected records for at least one search request, including at least one of accessing treatment options stored within the database suitable for optimizing performance of the refining process; performance analysis including predicting performance and determining the probability and distribution of problems during the refining process; and treatment analysis.

16. The method in accordance with claim 10, wherein the search criteria for a search request include a unique fuzzy parameter corresponding to respective search parameters of the at least one search parameter for specifying at least one of a first range of values extending above the target value and a second range of values extending below the target value, wherein the first and second ranges define the relationship to the target value, and wherein the search criteria are met within the first and second ranges, and the degree of membership varies with respect to a difference between a value within the range and the target value.

17. A computer readable medium storing a set of instructions configured for execution by at least one processor for performing the steps of:
accessing a database for obtaining data related to at least one of a plurality of crudes, crude slates and refinery operating conditions, stored in a plurality of records, each record having at least one field storing data; and
executing at least one fuzzy search comprising the steps of:
receiving at least one search request, respective search requests include search criteria including at least one search parameter specifying a field of the at least one field and a search criteria type corresponding to each search parameter specifying a target value and a relationship to the target value;
computing for each respective search parameter of the at least one search parameter a degree of membership value for individual records of the plurality of records in accordance with at least one continuous varying function describing a degree of meeting the search criteria type corresponding to the respective search parameter by data stored in the field specified by the respective search parameter; and
computing a closeness value for each individual record in accordance with a function combining the degree of membership value for each respective search parameter.

18. The computer readable medium in accordance with claim 17, further performing the step of outputting a list of records of the individual records ranked in order in accordance with the closeness value corresponding to each of the listed records.

19. The computer readable medium in accordance with claim 17, wherein the search criteria further includes a weight value corresponding to respective search parameters of the at least one search parameter, and wherein the computing a closeness value step includes the step of weighting each degree of membership value for each respective search parameter in accordance with the corresponding weight value.

20. The computer readable medium in accordance with claim 17, wherein the relationship to a target value x specified by the search criteria type includes x bounded by at least one of an upper and a lower bound.

21. The computer readable medium in accordance with claim 17, further performing the steps of:
outputting a list of records of the individual records and the respective corresponding computed closeness value; and
receiving input for selecting records from the list of records.

22. The computer readable medium in accordance with claim 21, further performing the step of processing data included in the selected records for determining desirability of at least one combination of the selected records for at least one search request, including at least one of accessing treatment options stored within the database suitable for optimizing performance of the refining process; performance analysis including predicting performance and determining the probability and distribution of problems during the refining process; and treatment analysis.

23. The computer readable medium in accordance with claim 17, wherein the search criteria for a search request includes a unique fuzzy parameter corresponding to respective search parameters of the at least one search parameter for specifying at least one of a first range of values extending above the target value and a second range of values extending below the target value, wherein the first and second ranges define the relationship to the target value, and wherein the search criteria are met within the first and second ranges, and the degree of membership varies with respect to a difference between a value within the range and the target value.
